(19) United States
(12) Patent Application Publication
(10) Pub. No.: US 2014/0095304 A1
(43) Pub. Date: Apr. 3, 2014

(54) Providing Notifications for Redeeming Offers Based on External Signals

(71) Applicant: Jaikumar Ganesh, San Francisco, CA (US)

(72) Inventor: Jaikumar Ganesh, San Francisco, CA (US)

(21) Appl. No.: 13/633,820

(22) Filed: Oct. 2, 2012

(51) Int. Cl. G06Q 30/02

(52) U.S. Cl. 705/14.49

(57) ABSTRACT

A system and methods for automatically generating and providing notifications with suggestions of unredeemed offers to users who have acquired them, based on external signals that are generated by determining user interests, for example, user intentions, user actions, or significant events relating to users. The user interests may be determined from multiple sources for example, emails, calendars, locations, searches, social network streams, social graphs, etc. This technology searches through unredeemed offers associated with users and co-relates them with user interests to identify unredeemed offers that may be appropriate to the user interests and generates notifications suggesting the appropriate unredeemed offers before they expire. The notifications may be provided to users via email, instant messaging, social streams, SMS/MMS messages, telephone calls, among other methods for electronic communication.

### BACKGROUND

The present disclosure relates to electronic systems and user interfaces for generating and providing notifications.

In the last decade or so, with the growth in electronic communications and commerce, people typically purchase offers, coupons, deals, or bargains, via online venues, for example, websites. Many people are unable to resist a bargain or a fair price for a particular item or service and quickly purchase offers indicating special deals; yet they often forget to redeem the offers. In many instances, the offers or coupons have constraints, for example, expiration dates, which are difficult for users to keep track of.

### SUMMARY

According to one innovative aspect of the subject matter described in this disclosure, a system for providing notifications to redeem offers based on external signals is described. The system retrieves user information relating to a user interest; generates an external signal based on the user interest; co-relates the user interest with a plurality of unredeemed user offers based on the external signal, identifies an appropriate unredeemed offer for the user interest; generates a notification suggesting the appropriate unredeemed offer to the user; and provides for display to the user, the notification including the appropriate unredeemed offer.

In general, one innovative aspect of the subject matter described in this disclosure may be embodied in methods that include retrieving, using a computing device, user information relating to a user interest from a source associated with a user; generating, using the computing device, an external signal based on the user interest; co-relating the user interest with a plurality of unredeemed user offers based on the external signal and identifying an unredeemed offer appropriate for the user interest; generating, using the computing device, a notification suggesting the unredeemed offer to the user; and providing for display to the user, using the computing device, the notification including the appropriate unredeemed offer.

Other implementations of one or more of these aspects include corresponding systems, apparatus, and computer programs, configured to perform the actions of the methods, encoded on computer storage devices.

These and other implementations may each optionally include one or more of the following features. For instance, the features include: user information including one of a group of a user email, a calendar item, a location, a search, a social network stream, and a social graph relating to the user; determining a location via a global positioning system; performing a search via a search capability; the user interest including a user intention; the user interest including a user action; and the user interest including one of a user preference or a significant event of interest to the user.

For instance, the operations further include: determining, using the computing device, user permission for retrieving the user information from a source; the user information including one of a group of a user email, a calendar item, a location, a search, a social network stream, and a social graph associated with the user; determining the location via a global positioning system; performing a search via a search capability; the user interest including a user intention; the user interest including a user action; the user interest including one of a user preference and a significant event of interest to the user.

The systems and methods disclosed below can be advantageous in a number of respects. First, they are able to prevent unredeemed offers that users may have forgotten about from being unnecessarily wasted. Second, proper use of offers or coupons would not only be beneficial to the users who acquire them, but would continue to offer economical and efficient shopping mechanisms promoting continued purchase or acquisition of bargains and discounts that are typically offered to users via the internet, websites, emails, or otherwise.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram illustrating an example system for automatically generating and providing notifications to redeem unused offers based on external signals.

FIG. 2 is a block diagram illustrating an example offer notification application including its hardware components.

FIG. 3 is a block diagram illustrating the offer notification application including its software components.

FIG. 4 is a block diagram illustrating an example user interest determination module in the offer notification application.

FIG. 5 is a flow chart of an example general method for providing notifications for redeeming unused offers based on external signals.

FIG. 6 is a flow chart of an example method for determining user interests from different sources.

FIG. 7 is a flow chart of an example method for generating external signals.

FIGS. 8-16 are graphical representations of examples of user interfaces for presenting notifications of unused offers.

### DETAILED DESCRIPTION

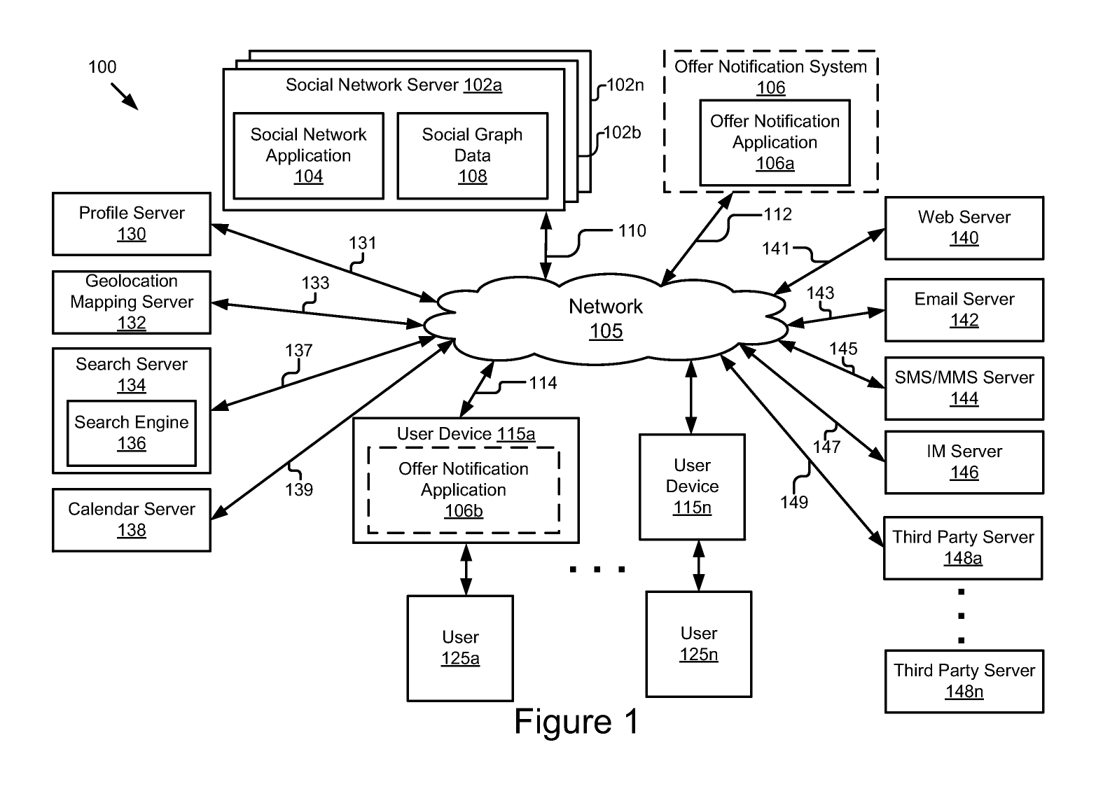

FIG. 1 is a block diagram illustrating some implementations of system architecture for automatically generating and providing notifications to redeem unused offers based on external signals. The system 100 includes user devices 115a through 115n, used by users 125a through 125n, to connect and communicate with a server, for example, any one of social network servers 102a, 102b through 102n, a geolocation server 132, a search server 134 (including a search engine 136), a calendar server 138, a web server 140, an email server 142, an sms/mms server 144, an IM server 146, and third party servers 148a through 148n. The system 100 also includes an offer notification system 106a. These entities are communicatively coupled via a network 105.

The present technology is described in the context of automatically generating and providing notifications with suggestions to redeem unused offers based on externals signals, which in some implementations include, but are not limited to, the sources described here. Moreover, the description of the present technology is described only in reference to redeeming unused offers that have been previously acquired, by purchase, or designated for purchase. Moreover, the present technology is described in the context of electronic communications, which in some implementations, include, but are not limited to, communications that occur or messages that are exchanged in a social network, via instant messages, via Short Message Service (SMS)/Multimedia Messaging Service (MMS) messages, etc.

The user devices 115a through 115n in FIG. 1 are illustrated by way of example. Although FIG. 1 illustrates only two user devices, the present disclosure applies to any system architecture with one or more user devices 115; therefore, any number of user devices 115n may be used. Furthermore, whereas only one network 105 is illustrated as coupled to the user devices 115a through 115n, the social network servers, 102a-102n, the profile server 130, the geolocation server 132, the search server 134 (including a search engine 136), the calendar server 138, the web server 140, the email server 142, the sms/mms server 144, the IM server 146, and the third party servers 148a through 148n, in practice, any number of networks 105 may be connected to these entities. In addition, although only two third party servers 148a through 148n are shown, the system 100 may include any number of third party servers 148n.

The user devices 115a through 115n are configured to communicate with any of the servers indicated above, via the network 105. The user devices 115a through 115n may be a computing device, for example, a laptop computer, a desktop computer, a tablet computer, a mobile telephone, a personal digital assistant (PDA), a mobile email device, a portable game player, a portable music player, a television with one or more processors embedded in the television or coupled to it, or any other electronic device capable of accessing a network.

The network 105 may include links using technologies for example Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 105 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 105 can be represented using technologies and/or formats including the hypertext markup language (HTML), the extensible markup language (XML), etc. In addition, all or some of links can be encrypted using conventional encryption technologies for example the secure sockets layer (SSL), Secure HTTP and/or virtual private networks (VPNs) or Internet Protocol security (IPsec). In some implementations, the entities may use custom and/or dedicated data communications technologies instead of, or in addition to, the ones described above. Depending upon the implementation, the network 105 can also include links to other networks.

In some implementations, the network 105 may be a partially public or a wholly public network for example the Internet. The network 105 can also be a private network or include one or more distinct or logical private networks (for example, virtual private networks, Wide Area Networks (“WAN”) and/or Local Area Networks (“LAN”)). Additionally, the communication links to and from the network 105 can be wire line or wireless (i.e., terrestrial—or satellite-based transceivers). In some implementations, the network 105 may be an IP-based wide or metropolitan area network.

The network 105 may be of conventional type, wired or wireless, and may have any number of configurations for example, a star configuration, a token ring configuration, or other configurations that are used in the field. Furthermore, the network 105 may comprise a local area network (LAN), a wide area network (WAN, for example, the Internet), and/or any other interconnected data path across which one or more devices may communicate.

In some implementations, the network 105 may be a peer-to-peer network. The network 105 may also be coupled to or include portions of one or more telecommunications networks for sending data in a variety of different communication protocols.

In some implementations, the network 105 includes Bluetooth communication networks or a cellular communications network for sending and receiving data for example via short messaging service (SMS), multimedia messaging service (MMS), hypertext transfer protocol (HTTP), direct data connection, WAP, email, etc.

In some implementations, the social network server 102a may be coupled to the network 105, via a signal line 110. The social network server 102a includes a social network application 104, which comprises the software routines and instructions to operate the social network server 102a and its functions and operations. Although only one social network server 102a is described here, multiple servers may be present, as illustrated by social network servers 102b through 102n, each with functionality similar to social network server 102a or different.

The term “social network” as used here encompasses its plain and ordinary meaning including, but not limited to, any type of social structure where the users are connected by a common feature or link. The common feature includes relationships/connections, for example, friendship, family, work, a similar interest, etc. The common features are provided by one or more social networking systems, for example those included in the system 100, including explicitly-defined relationships and relationships implied by social connections with other online users, where the relationships form the social graph 108.

The term “social graph” as used here encompasses its plain and ordinary meaning including, but not limited to, a set of online relationships between users, for example provided by one or more social networking systems, for example, the social network system 100, including explicitly-defined relationships and relationships implied by social connections with other online users, where the relationships form a social graph 108. In some examples, the social graph 108 may reflect a mapping of these users and how they are related.

The social network server 102a and the social network software/application 104 are representative of a single social network. Each of the plurality of social network servers 102a, 102b through 102n, can be coupled to the network 105, each having its own server, application, and social graph. For example, a first social network hosted on a social network server 102a may be directed to business networking, a second on a social network server 102b directed to or centered on academics, a third on a social network server 102c (not shown) directed to local business, a fourth on a social network server 102d (not shown) directed to dating, and yet others on social network server (102n) directed to other general interests or perhaps a specific focus.

A profile server 130 is illustrated as a stand-alone server in FIG. 1. In some implementations of the system architecture 100, all or part of the profile server 130 may be part of the social network server 102a. The profile server 130 can be connected to the network 105, via a line 131. The profile server 130 has profiles for all the users that belong to a particular social network 102a-102n.

The geolocation mapping server 132 can be coupled to the network 105, via a signal line 133, and provides real-world geographic location data, for example, to a global positioning system.

The search server 134 can be coupled to the network 105, via a signal line 137, and can process search queries from user devices 115a through 115n. The search server 134 includes the search engine 136, which processes search queries and returns search results to any one of the user devices 115a through 115n, for presentation to the respective one of users 125a through 125n.

A calendar server 38 can be coupled to the network, via a signal line 139, and provides calendar invitations or notifications of events to any of the user devices 115a through 115n.

One or more third party servers 148a through 148n are coupled to the network 105, via signal line 135. A web server 140 is connected, to the network 105, via line 141. The web server 140 provides access by one or more of the user devices 115a through 115n, to any the social network servers 102a through 102n, or one or more of the third party servers 148a through 148n. An IM server 146 is coupled to the network 105, via a signal 147, and a sms/mms server 144 is coupled to the network, via a line 145. An email server 142 is coupled to the network 105, via a line 143 and a web server 140 is coupled to a line 141.

An offer notification system 106 includes an offer notification application 106a (for suggesting unused offers) that can be configured to determine user information from any of the multiple sources described above. The user information may be user actions, intentions, or significant events associated with the users. The user devices 115a through 115n are coupled, via the network 105, to the multiple sources that are described above, and can exchange communications and/or messages. In particular, user device 115a is coupled, via line 114, to the network 105. The user 125a, via the user device 115a, can access any one of the servers. The offer notification system 106 may be configured as an “application” or certain components of it may be stored in a distributed architecture in any of the servers or the user device 115a (indicated as offer notification application 106b). In some implementations, the offer notification application 106a (or b) may be included entirely, in an offer notification system 106 associated with any of the servers or the user device 115 (a through n).

In some implementations, the social network servers, 102a-102n, the profile server 130, the geolocation mapping server 132, the search server 134, the calendar server 138, the web server 140, the email server 142, the sms/mms server 144, the IM server 146, and the third party servers 148a through 148n are hardware servers including a processor, memory, and network communication capabilities. One or more of the users 125a through 125n can access any of the social network servers 102a through 102n, or the other servers, via browsers in their user devices 115a through 115n and via the web server 140.

As one example, in some implementations of the system architecture, information on particular users (125a through 125n) connected by a social network can be retrieved from the social graph 108. It should be noted that any information that is retrieved for particular users is only upon obtaining the necessary permissions from the users, in order to protect user privacy and any sensitive information of the users. User content can be retrieved from one or more the social network servers 102a through 102n, the profile server 130, the web server 140, and the third party servers 148a through 148n. Messages or communications among users can be retrieved from the email server 142, the SMS/MMS server 144, and the IM server 146. Calendar items for users can be retrieved from the calendar server 138 and location information for users can be retrieved from a geolocation mapping server 132.

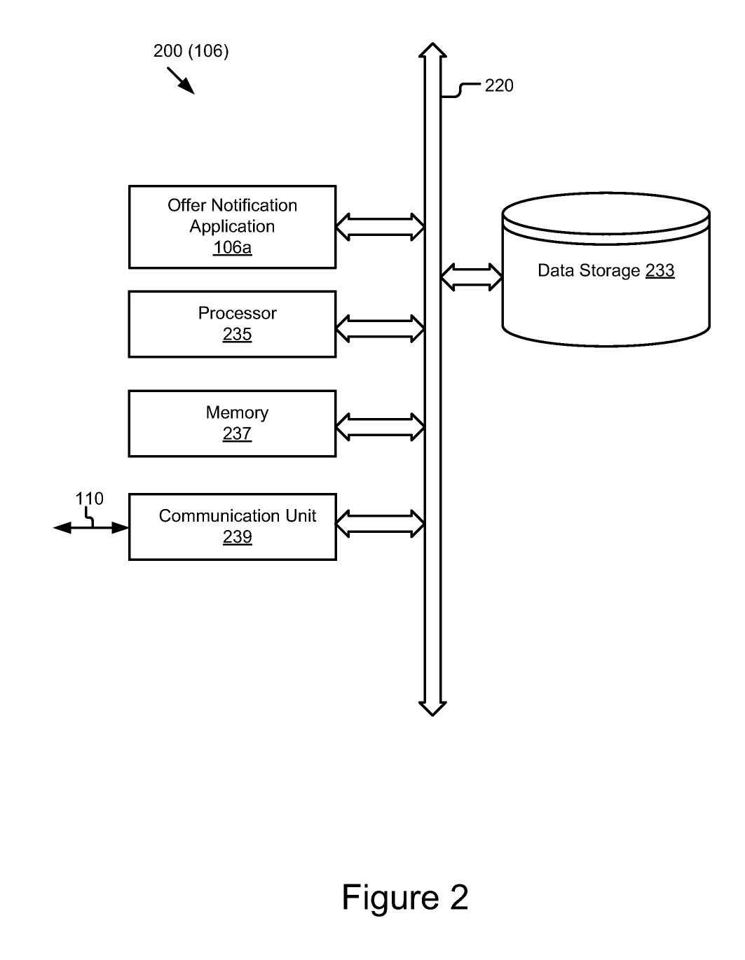

FIG. 2A is a block diagram illustrating some implementations of an unused offer notification system 200. In FIG. 2, like reference numerals have been used to reference like components with the same or similar functionality that has been described above with reference to FIG. 1. As those components have been described above, that description is not repeated here. The processor 235 comprises an arithmetic logic unit, a microprocessor, a general purpose controller, or some other processor array to perform computations, provide electronic display signals to display to the user device 115a-115n (FIG. 1). The processor 235 can be coupled to a bus 220 for communication with the other components of the system 200. The processor 235 processes data signals and may comprise various computing architectures including a complex instruction set computer (CISC) architecture, a reduced instruction set computer (RISC) architecture, or an architecture implementing a combination of instruction sets. Although only a single processor is shown in FIG. 2, multiple processors may be included. The processor can be coupled, via the bus 220, to memory 237 and data storage 233.

In some implementations, data storage 233 stores data and information for the users 125a-125n. Stored user information may include user profiles, user identifications, or other information indicating their intentions, actions, or significant events associated with them. In some implementations, examples of user information can include, but are not limited to, a user's name, contact information, relationship status, likes, interests (intentions and actions), links, location, activities (social or otherwise), etc. The user information indicates user content and patterns. Social activity for a user can include, but is not limited to, data or information regarding communications, transactions, sharing, social connections, and feature usage within the system 100 (FIG. 1). Examples of communications data and information that may qualify as social activity include, but are not limited to, the subject, content, dates, senders, or recipients of communications. Examples of transactions data and information that may qualify as social activity include, but are not limited to, the identity of the user acquiring an offer, a list of offers purchased, the price(s) at which they were purchased, the total number of offers per user, and the date that the offers were purchased and/or expire. Examples of sharing data and information that may qualify as social activity include, but are not limited to, what was shared, when something was shared, and with whom something is shared. Examples of social connections data and information that may qualify as social activity include, but are not limited to, the identity of present, or past, friends, relatives, acquaintances, and frequent contacts. Examples of feature usage data and information that may qualify as s social activity include, but are not limited to, include applications (for example, global positing system applications) used, search histories, and calendar invitations and notification of events.

The storage device 233 can be any device capable of holding data, like a hard drive, compact disk read-only memory (CD-ROM), DVD, or a solid-state memory device. The storage device 233 can be a non-volatile memory device or similar permanent storage device and media. The storage device 233 stores data and instructions for processor 235 and comprises one or more devices including a hard disk drive, a floppy disk drive, a CD-ROM device, a DVD-ROM device, a DVD-RAM device, a DVD-RW device, a flash memory device, or some other mass storage device known in the art. In some implementations, the storage device 233 can be used to store data and information including social activity or other communications of users 125a and 125n of the system 100 (FIG. 1).

The social network server 102a-n (FIG. 1) includes software and routines executable by the processor 235 to control the interaction between the data storage 233 and the user devices 115a and 115n. An implementation of the social network server 102a-102n allows users 125a and 125n of user devices 115a and 115n, to interact and perform social activities, including social communication, between other users 125a and 125n of user devices 115a and 115n.

In some implementations, the email server 142 (FIG. 1) enables users to exchange digital messages across the internet or other computer networks (over the network 105). The e-mail server 142 includes software and routines executable by the processor 235 to control the interaction between the data storage 233 and the user client devices 115a, 115n. An implementation of the e-mail server 142 allows users 125a, 125n of user devices 115a, 115n to exchange digital messages with other users 125a, 125n of user devices 115a, 115n within the system 100. In some implementations, this exchange of such digital messages can be social activity.

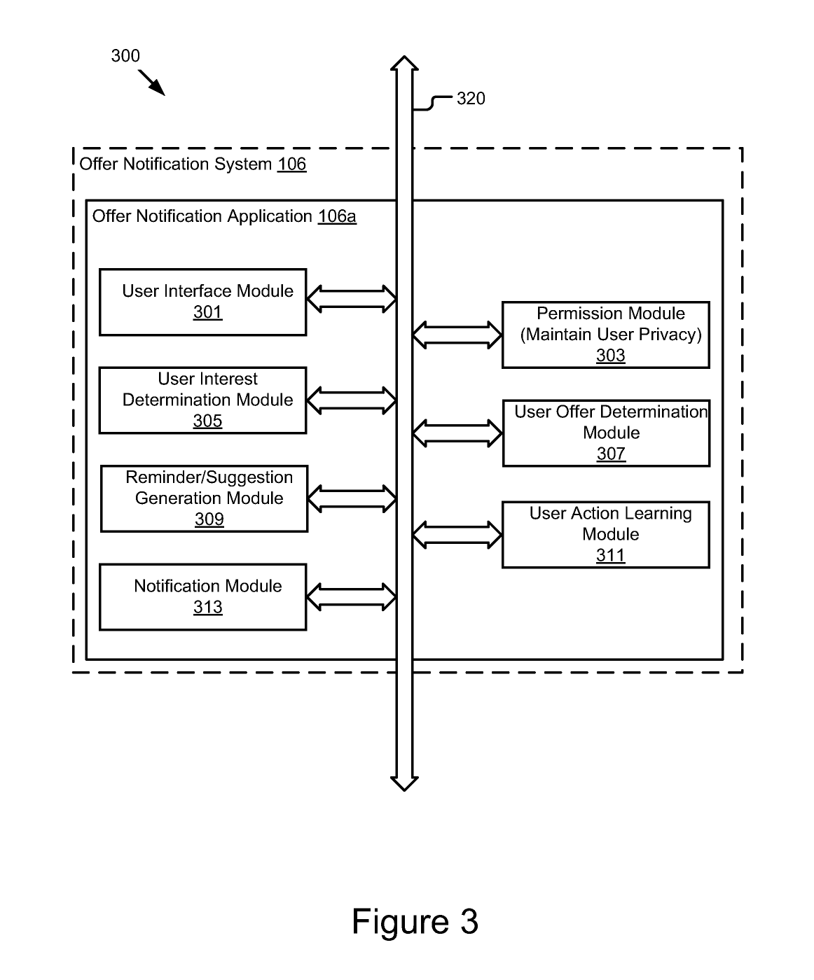

Referring now to FIG. 3, like reference numerals have been used to reference like components with the same or similar functionality that is described above with reference to FIGS. 1 and 2. For the components that have been described above, the description relating to them is not repeated here. The offer notification application 106 (and b), indicated here by reference numeral 300, includes various modules that are programmed to perform the functionalities described here.

The offer notification application 106 includes a user interface module 301, via which particular users communicate with one other users. The user interface module 301 can be software including routines for establishing or managing a user interface. In some implementations, the user interface module 301 may be a set of instructions executable by the processor 235 to provide the functionality described below for managing a user interface. In some implementations, the offer use generation application 106 including the user interface module 301 may be stored in the memory 237 of the system 200 and may be accessible and executable by the processor 235. In either implementation, the user interface module 301 may be adapted for cooperation and communication with the processor 235, the communication unit 241, data storage 239, and other components of the offer notification application 106 via the bus 320.

A user profile in a social network can be a collection of data associated with any particular user. A user's profile may include a person's characteristics as well as preferences.

The offer notification application 106 includes a permission module 303, which manages user privacy, by seeking user permission or consent before retrieving profile information. The permission module 303 can be software including routines for managing permissions. In some implementations, the permission module 303 may be a set of instructions executable by the processor 235 to provide the functionality described below for managing permissions. In some implementations, the offer notification application 106 (a and b) including the permission module 303 may be stored in the memory 237 (FIG. 2) and may be accessible and executable by the processor 235. In either implementation, the permission module 303 may be adapted for cooperation and communication with the processor 235, the communication unit 239, data storage 233, and other components of the offer notification application 106 (a and b) via the bus 320.

The offer notification application 106 further includes a user interest determination module 305 configured to determine user interests, for example, their intentions (present or future), their actions or activities, significant events that may be of interest to them etc. Upon obtaining the user information, a user offer determination module 307 of the offer notification application 106 can review a record of unused offers associated with particular users, and co-relate them, by searching through the record, to find an appropriate unused offer that is pertinent to a particular user's intention, action (or activity), or event. When an appropriate unused offer is identified, the reminder/suggestion generation module 309 can generate a suggestion or reminder with the appropriate unused offer. A notification module 313 generates a notification with the suggestion of the appropriate unused offer and provides it to a particular user for display at the appropriate time.

The user action learning module 311 can receive information relating to a user interacting with offers (after obtaining permission to maintain user privacy) over time and modifies one or more functionalities of the offer notification application 106 to better accommodate and serve user needs.

All the modules communicate over the software communication mechanism 320. Software communication mechanism 320 may be an object bus (for example CORBA), direct socket communication (for example TCP/IP sockets) among software modules, remote procedure calls, UDP broadcasts and receipts, HTTP connections, function or procedure calls, etc. Further, any or all of the communication could be secure (SSH, HTTPS, etc.). The software communication may be implemented on any underlying hardware, for example a network, the Internet, a bus 220 (FIG. 2A), a combination thereof, etc.

Implementations of the entities described herein can include other and/or different modules than the ones described here. In addition, the functionality attributed to the modules can be performed by other or different modules in other implementations. Moreover, this description occasionally omits the term “module” for purposes of clarity and convenience.

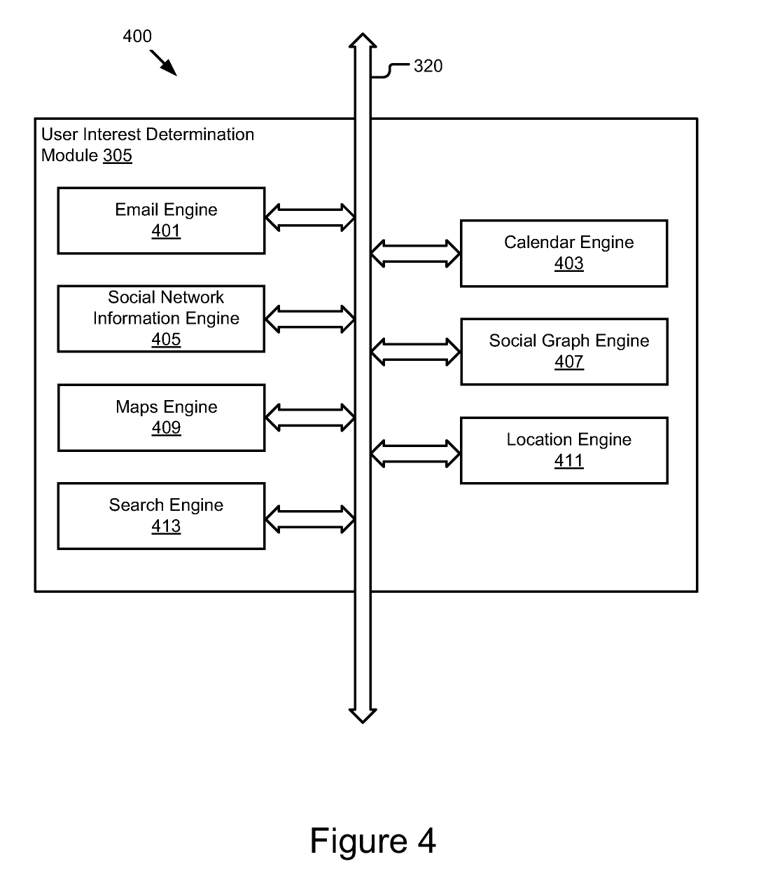

Referring now to FIG. 4, the user interest determination module 305 includes an email engine 401 that can retrieve user intentions from email information, for example, email communications between two users (125a and 125n). The email engine 401 may include software and routines executable by the processor 235 for retrieving user intentions from user email threads. In some implementations, the email engine 401 can be a set of instructions executable by the processor 235 to provide the functionality described below for retrieving user intentions from emails. In some implementations, the email engine 401 can be stored in the memory 237 of the system 200 and can be accessible and executable by the processor 235. The email engine 401 may be adapted for cooperation and communication with the processor 235 and other components of the user interest determination module 305.

The user interest determination module 305 further includes a calendar engine 403 that can retrieve user intentions from a user's calendar, for example, calendared items. Also, the calendar engine 403 can inform a user of upcoming events and remind the user of unused offers that pertain to those events. The calendar engine 403 may include software and routines executable by the processor 235 for determining user intentions from user calendared items. In some implementations, the calendar engine 403 can be a set of instructions executable by the processor 235 to provide the functionality described below for retrieving user intentions from calendared items or events. In some implementations, the calendar engine 403 can be stored in the memory 237 of the system 200 and can be accessible and executable by the processor 235. The calendar engine 403 may be adapted for cooperation and communication with the processor 235 and other components of the user interest determination module 305.

The user interest determination module 305 includes a social network information engine 405 that retrieves user intentions from social networks, for example, social posts by users of the social networks (for example, 125a and 125n). The social network information engine 405 may include software and routines executable by the processor 235 for retrieving user intentions from user social posts. In some implementations, the social network information engine 405 can be a set of instructions executable by the processor 235 to provide the functionality described below for retrieving user intentions from social posts. In some implementations, the social network information engine 405 can be stored in the memory 237 of the system 200 and can be accessible and executable by the processor 235. The social network information engine 405 may be adapted for cooperation and communication with the processor 235 and other components of the user interest determination module 305.

The user interest determination module 305 includes a social graph engine 407 that retrieves user intentions from a user's social graph, for example, communications between users in a social thread (for example, 125a and 125n). The social graph engine 407 may include software and routines executable by the processor 235 for retrieving user intentions from a social graph. In some implementations, the social graph engine 407 can be a set of instructions executable by the processor 235 to provide the functionality described below for retrieving user intentions from a social graph. In some implementations, the social graph engine 407 can be stored in the memory 237 of the system 200 and may be accessible and executable by the processor 235. The social graph engine 407 may be adapted for cooperation and communication with the processor 235 and other components of the user interest determination module 305.

The user interest determination module 305 further includes a maps engine 409 that retrieves user intentions from map information, for example, searches by a user for certain destinations. The maps engine 409 may include software and routines executable by the processor 235 for retrieving user intentions from map information. In some implementations, the maps engine 409 can be a set of instructions executable by the processor 235 to provide the functionality described below for retrieving user intentions from map information. In some implementations, the maps engine 409 can be stored in the memory 237 of the system 200 and can be accessible and executable by the processor 235. The maps engine 409 may be adapted for cooperation and communication with the processor 235 and other components of the user interest determination module 305.

The user interest determination module 305 includes a location engine 411 that retrieves user locations from a global positioning system (“GPS”), for example, when a user is searching for a particular destination or is driving to a particular destination of interest to the user. The location engine 411 may include software and routines executable by the processor 235 for retrieving user locations from a global positioning system. In some implementations, the location engine 411 can be a set of instructions executable by the processor 235 to provide the functionality described below for retrieving user locations. In some implementations, the location engine 411 can be stored in the memory 237 of the system 200 and can be accessible and executable by the processor 235. The location engine 411 may be adapted for cooperation and communication with the processor 235 and other components of the user interest determination module 305.

The user interest determination module 305 includes a search module 413 that retrieves user intentions from user searches for items or services of interest, for example, a search for a particular restaurant or a search for Italian food. The search module 413 may include software and routines executable by the processor 235 for retrieving user intentions from user searches. In some implementations, the search module 413 can be a set of instructions executable by the processor 235 to provide the functionality described below for retrieving user intentions from user searches. In some implementations, the search module 413 can be stored in the memory 237 of the system 200 and can be accessible and executable by the processor 235. The search module 413 may be adapted for cooperation and communication with the processor 235 and other components of the user interest determination module 305.

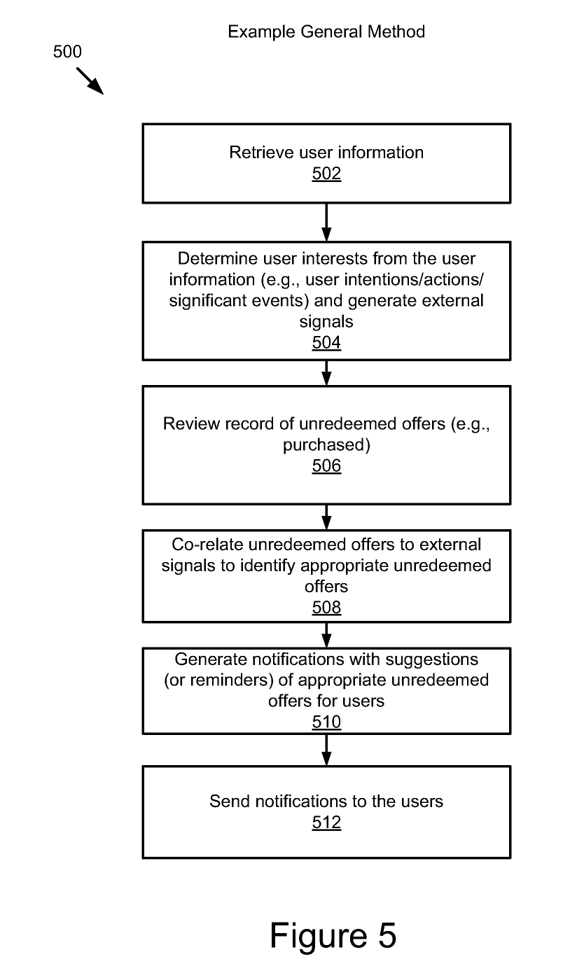

FIG. 5 is a flow chart illustrating one example of a general method for automatically generating and providing notifications for redeeming offers based on external signals. It should be understood that the order of the steps in FIG. 5 is merely by way of example and may be performed in different orders than those that are illustrated and some steps may be excluded, and different combinations of the steps may be performed. The method 500 may include retrieving (502) user information for one or more users. As described above, in some implementations, the user information may be obtained from any source (email, calendar, social network, etc.) The method 500 may include determining (502) intentions of the one or more users from the user information that is obtained (for example, user actions, activities, or events in the present or the future). The method 500 may include reviewing (506) a record of unused offers. For example, a record may take the form of lists of previously obtained or purchased offers, coupons, bargains, deals etc., associated with a particular user that have not been redeemed. The method 500 may include determining (508) any unredeemed offers that are deemed pertinent to a user's intentions, actions, activities, calendared items, or upcoming events. The method 500 may include generating (510) one or more unused offer notifications (suggestions or reminders) for users that are appropriate to user intentions. The method 500 may include sending (512) one or more notifications to the one or more users including suggestions or reminders of unused offers that are deemed appropriate.

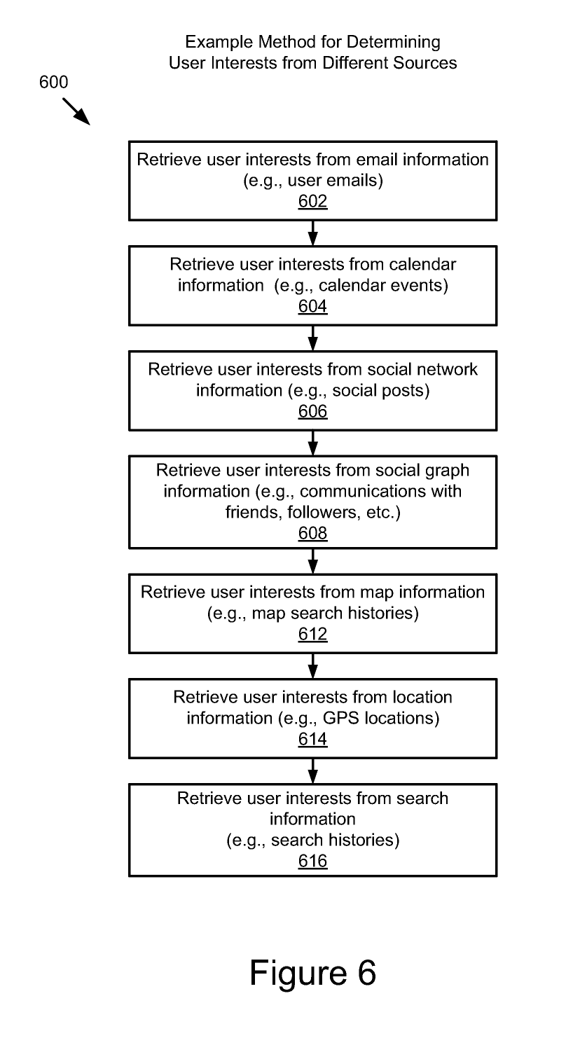

FIG. 6 is a flow chart illustrating one example of a method for determining user intentions from different sources. It should be understood that the order of the steps illustrated in FIG. 6 is merely by way of example and may be performed in different orders than those that are illustrated and some steps may be excluded, and different combinations of the steps may be performed. The method 600 may include retrieving (602) user interests from email information (for example, user emails). The method 600 may include retrieving (604) user interests from a user's calendar information (for example, calendar items or events). The method 600 may include retrieving (606) user interests from social network information and communications (for example, social posts). The method 600 may include retrieving (608) user interests from social graph information (for example, friends, followers, etc.). The method 600 may include retrieving (612) user interests from map information (for example, map search history). The method 600 may include retrieving (614) user interests from location information (for example, GPS location). The method 600 may include retrieving (616) user intentions from search information (for example, search history).

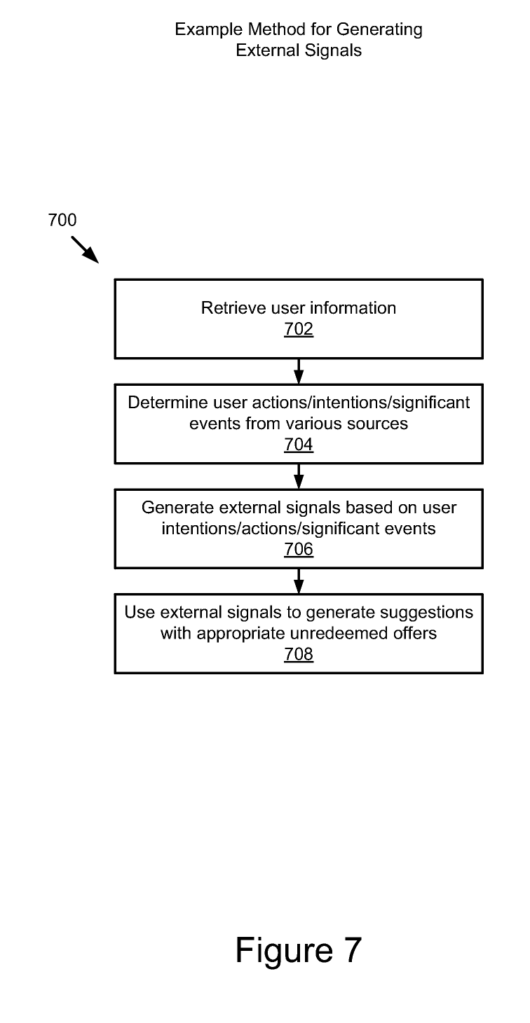

FIG. 7 is a flow chart illustrating an example method for determining user actions indicated generally by reference numeral 700. It should be understood that the order of the steps illustrated in FIG. 7 is merely by way of example and may be performed in different orders than those that are illustrated and some steps may be excluded, and different combinations of the steps may be performed. The method 700 may include retrieving (702) user information for one or more users. The method 700 may include determining (704) user actions/intentions/significant events for one or more users. The method 700 may include generating (706) external signals based on user preferences. The method 700 may include sending (708) external signals to generate notifications with appropriate unredeemed offers.

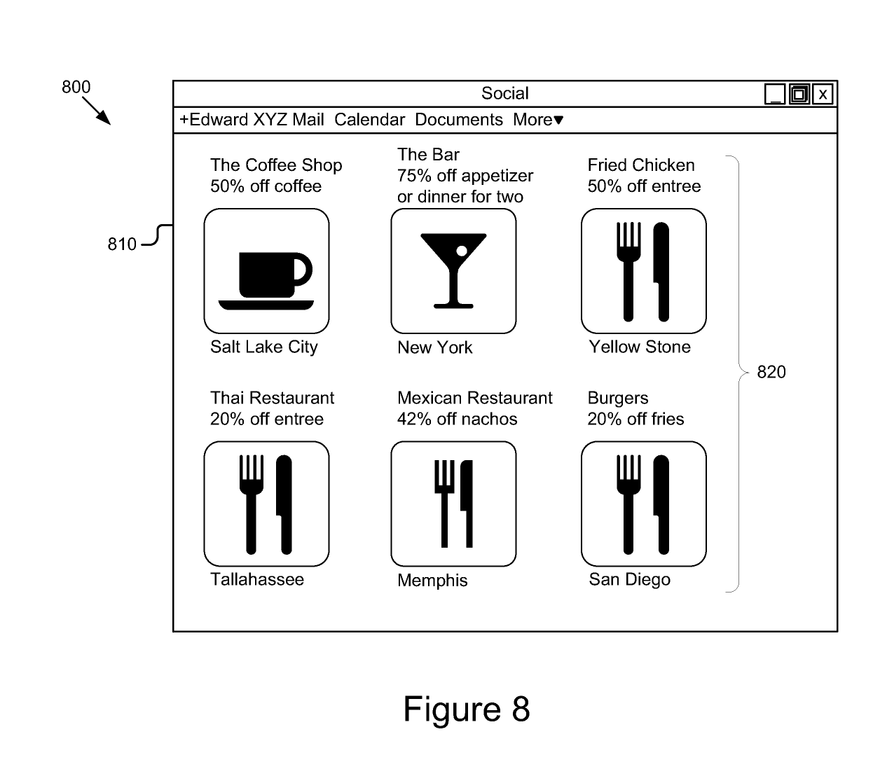

Referring now to FIGS. 8 through 16, various examples of different user interfaces configured to provide notifications to the users are illustrated. These notifications may be provided for display on the user devices 115a through 115n. The users may be notified in a variety of ways, for example, by email, via social networks, on their telephones or computers, etc. FIG. 8 illustrates a user interface display in a social network for a particular user (“Edward”) indicated generally by reference numeral 800. The user interface 800 provides a window display 810 with indications of various offers relating to the particular user, in this instance Edward. As one example, Edward may have purchased multiple offers (indicated by reference numeral 820), including a 50% discount for coffee at “The Coffee Shop” in Salt Lake, a 75% discount for an appetizer or dinner for two at “The Bar” in New York, a 50% discount for an entrée at the “Fried Chicken” in Yellowstone, a 20% discount on an entrée at a That restaurant in Tallahassee, a 42% discount on nachos at a Mexican Restaurant in Memphis, and 20% discount on fries at “Burgers” in San Diego. A user interface may therefore compile a list of offers acquired by a user and in some instances display them to the user.

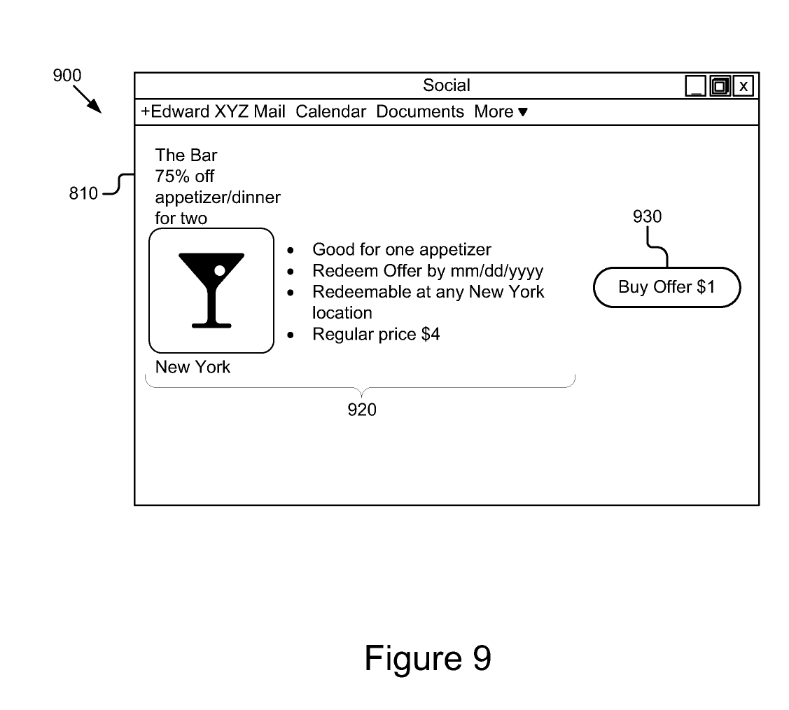

FIG. 9 illustrates an example user interface indicated generally by reference numeral 900. The user interface 90 may be one generated in a social network for the particular user (“Edward”) and illustrates the window display 810 with details 920 about the offer for “The Bar.” The offer specifies that it is good for one appetizer and must be redeemed by a particular date “mm/dd/yyyy,” in a particular location, in this instance, New York. The offer also specifies a regular price for the appetizer and indicates the discounted price at 930. It should be recognized that users of online communities may acquire one or more offers for subsequent use.

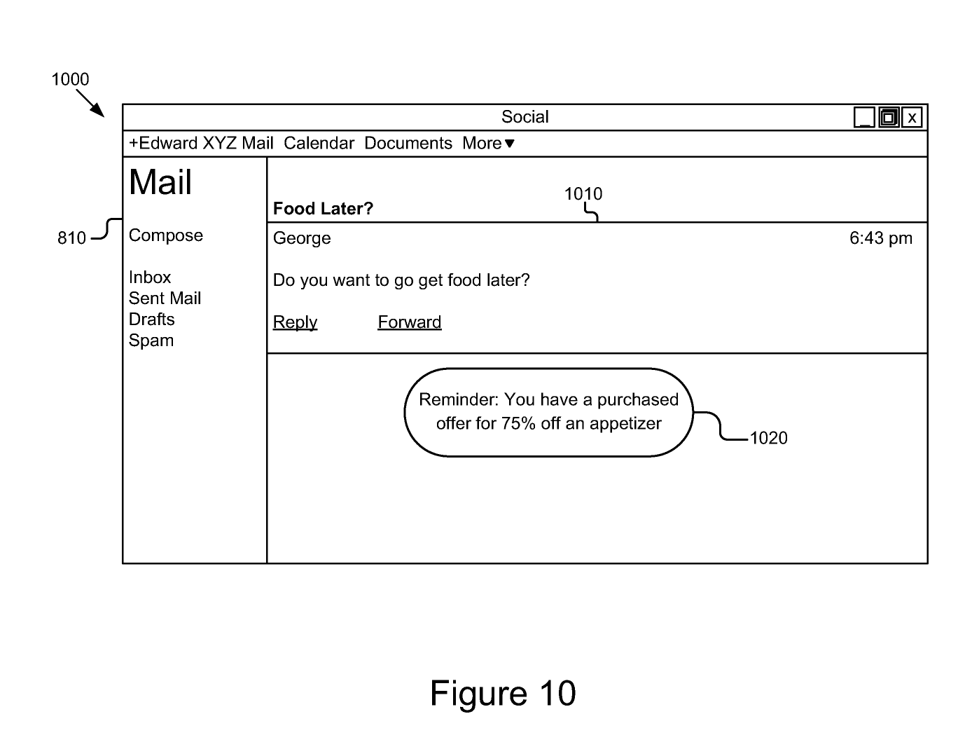

Referring now to FIG. 10, the offer notification application system 106 may provide a notification with a suggestion or reminder to a particular user (in this example, “Edward,”) via an example user interface 1000. In this instance, the display window 810 illustrates an email communication between a user “George” and Edward, with George inquiring if Edward wants to “get food later,” indicated by reference numeral 1010. Upon receiving this information, the offer notification application system 106 provides a notification with a reminder and presents it for display to Edward, as indicated by reference numeral 1020. This reminder suggests to Edward, that he may want to use an offer that he has already purchased, for example, an offer discounting an appetizer by 75% at “The Bar.” In some instances, the offer notification application system 106 may remind Edward of a purchased offer or coupon for dinner for two at a particular restaurant (not shown).

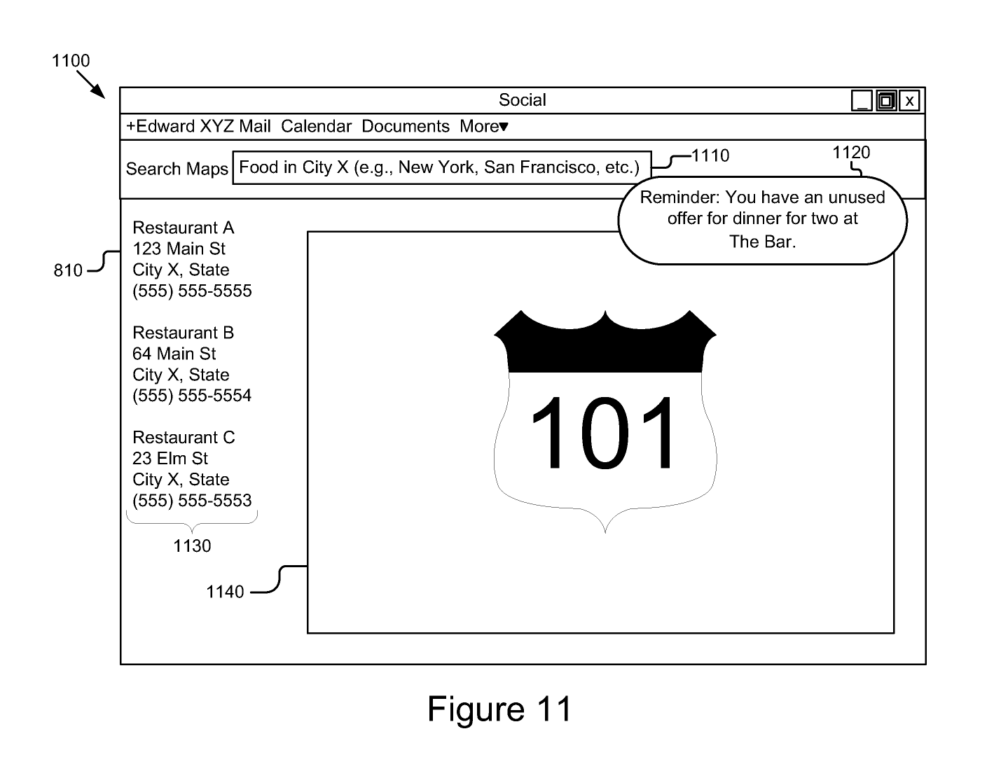

Referring now to FIG. 11, the offer notification application system 106 may provide notification reminding a particular user (“Edward” in this instance) of an unused offer, via an example user interface 1100. In this example, the offer notification application system 106 may receive information that Edward is searching on a search or mapping program (an “app”) for “food” in a particular city “X” (for example, New York or San Francisco). The search or mapping program may list recommendations of several restaurants, as indicated by reference numeral 1130, with an address and telephone numbers 1140. In this particular instance, the offer notification application system 106 may automatically generate and provide a notification and provide it for display on the display window 810. The notification suggests or reminds Edward that he may want to use the offer that he has already purchased, but not yet redeemed. In this illustrated example, the offer purchased is for an appetizer. In some instances, it may be for a dinner for two.

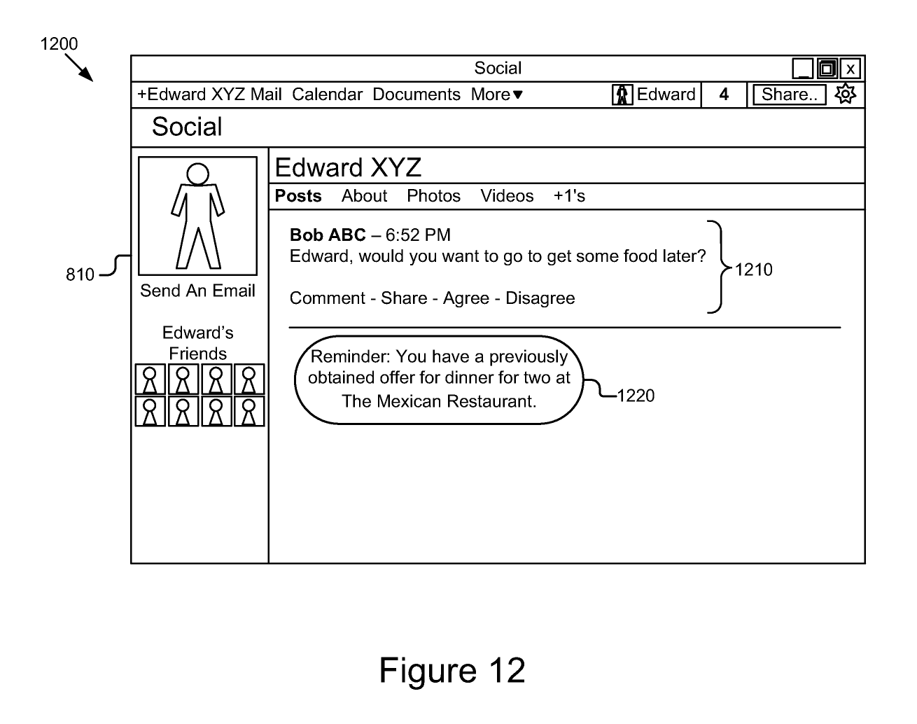

Referring now to FIG. 12, the offer notification application system 106 may automatically generate and provide a notification (1220) with a reminder to a particular user (for example, “Edward,”) via an example user interface 1200, in a situation, where it receives information from a social network communication, that two users are planning to meet. In the illustrated example, a friend “Bob ABC” posts a query to the particular user “Edward XYZ,” asking if the particular user wants to “get food later.”

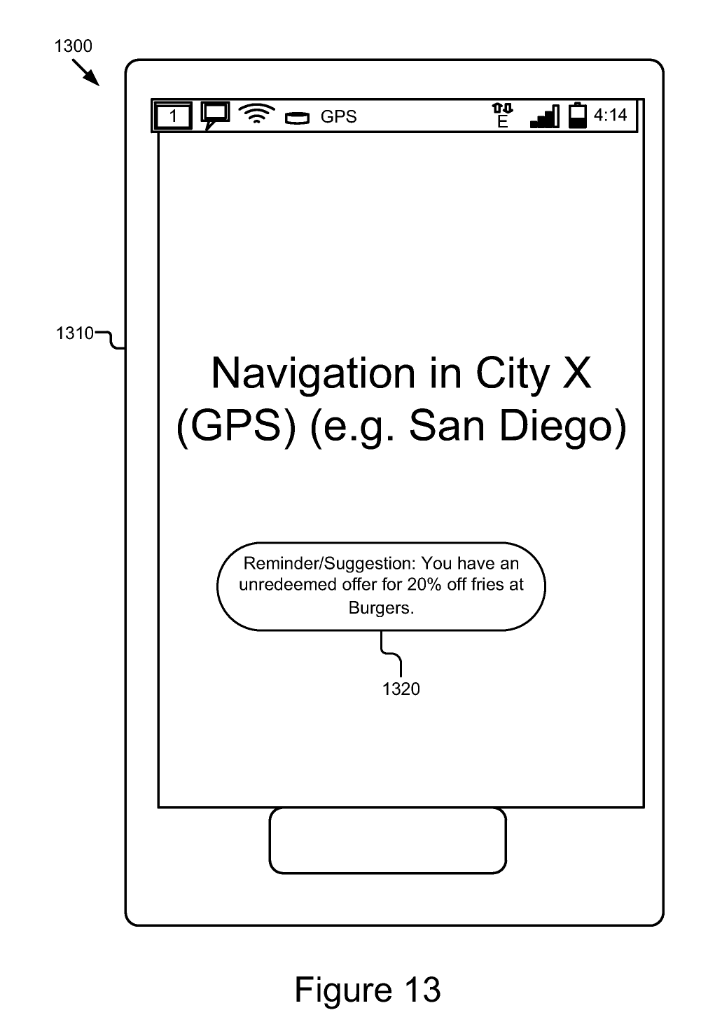

FIG. 13 illustrates an example of a user interface indicated by reference numeral 1300. In this instance, the offer notification application 106 may receive user information from a global positioning system on a particular user's location. The display window 1310 may be configured to display a reminder to the particular user that he or she has an unredeemed offer in or near the location that the user is driving by. The offer notification application system 106 may also simply consider the destination that the particular user is driving to and display offers or coupons that are unredeemed before the particular user actually arrives at his or her destination.

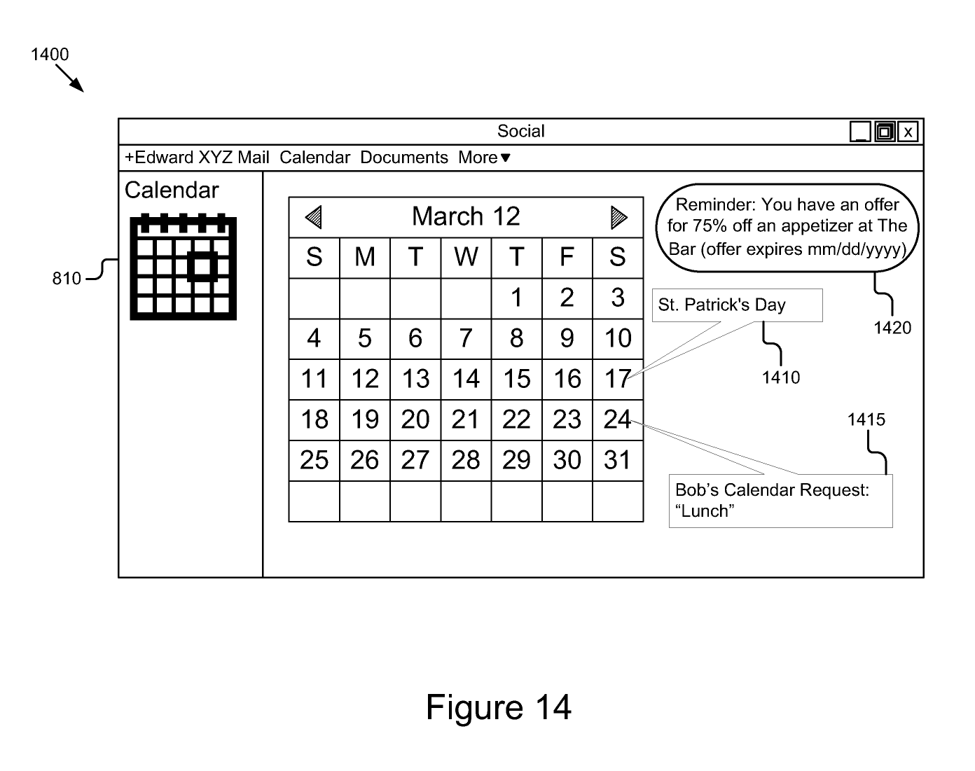

FIG. 14 illustrates a graphical representation of n example user interface indicated generally by reference numeral 1400. In this instance, the offer notification application system 106 receives information from a particular user's (again, Edward) calendar. For example, the display window 810 may indicate events that are noted on Edward's calendar. As one example, Edward's calendar indicates a celebration for St. Patrick's day is upcoming, indicated by 1410. As one example, Edward has a calendar invitation from a friend Bob for lunch on a particular day, as indicated by reference numeral 1415. Upon receiving information on these events, the offer notification application system 106 may automatically generate a reminder to the particular user (Edward) that he has an unredeemed offer or coupon for a discounted price for an appetizer with an indication of the expiration date for that offer or coupon, urging that he use it before it expires.

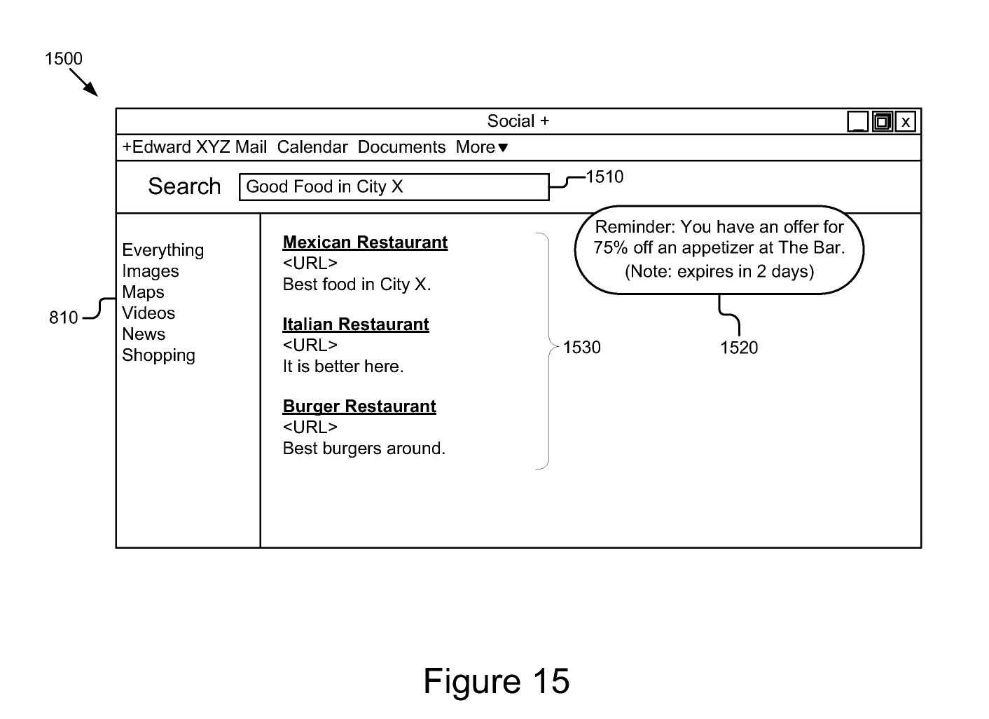

FIG. 15 illustrates a graphical representation of an example user interface indicated generally by reference numeral 1500. In this instance, Edward may simply be searching for “good food” in a particular city “X.” Edward indicates this search query in a text box 1510. The offer notification application system 106, upon receiving this information, may automatically generate and provide for display on Edward's user device 115a, several suggested restaurants (1530), for example, “Mexican,” “Italian,” and “Burger” restaurants with reviews of the restaurants and the food offered at the restaurants. In this instance, the offer notification application system 106 may automatically generate and provide for display to the particular user (“Edward”) a reminder that he has already purchased an offer or coupon (for a discount) for a food item (an appetizer) at a restaurant (“The Bar”), which expires in two days.

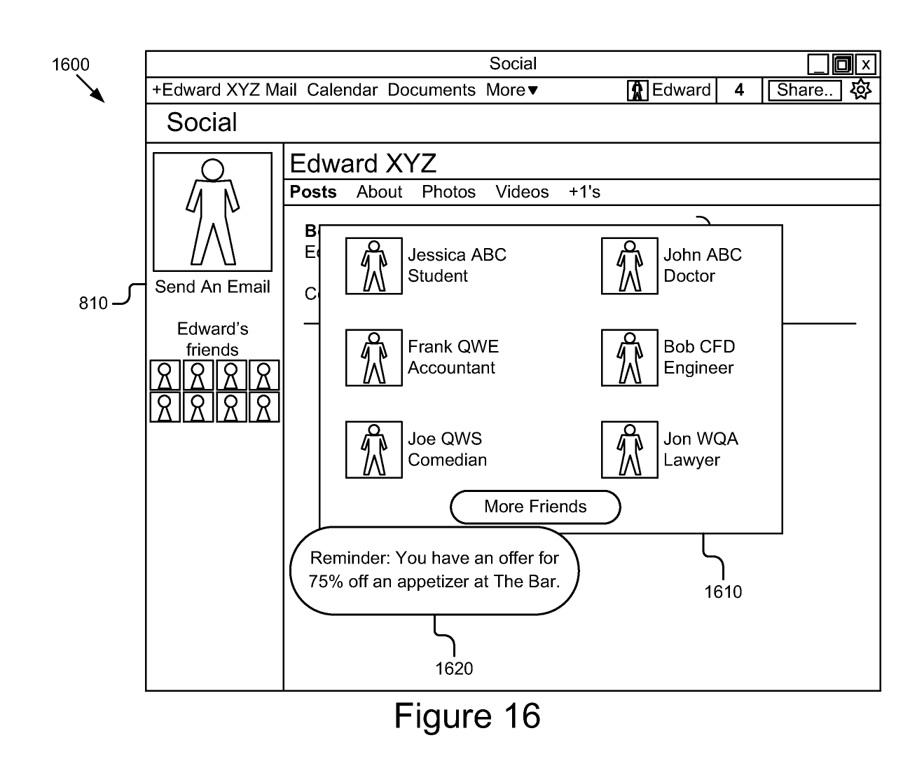

FIG. 16 illustrates a graphical representation of an example user interface indicated generally by reference numeral 1600. The offer notification application system 106 may determine the social graph for the particular user (for example, “Edward XYZ”), determine preferences of certain friends, and automatically generate notifications for redeeming purchased offers or coupons. For example, the offer notification application system 106 may indicate that certain friends like a particular food and provide for display to the particular user (“Edward XYZ”) a reminder that he has already purchased an offer or coupon (for a discount) for the particular food item (an appetizer).

In addition, the offer notification application 106 may receive (or determine) user information on user activities and preferences for individuals, groups, etc., for a myriad of different pursuits and activities, for example, for social activities (for example, movies, spa outings etc.), team activities (for example sport endeavors like skiing, paintball, go kart racing, etc.) or the like.

This technology is directed to determining intentions or activities associated with users, who are either connected within a social network, or are otherwise engaged in electronic communications and/or activities and automatically generating notifications with either suggestions or reminders for use of offers that the users may not have redeemed. Such offers (for example, coupons, purchased or pre-paid offers, transactions or deals) can be easily forgotten or never redeemed.

In some implementations of the technology, these suggestions or reminders are automatically generated based on external signals, which are further based on identifying user intentions or activities (for example, via email, calendars, locations, searches, social network streams, social graphs, etc.). In this way, .upon learning of an intention or activity of a particular user, this technology searches through all unredeemed offers for that particular user, and .co-relates them with the intention or activity, to generate a suggestion or reminder for use of a unredeemed offer that is determined to be suitable. And, particular users may be reminded to use their purchased offers before they expire.

In some implementations, notifications are provided to users in several ways, for example, via one or more emails, instant messaging, social streams, SMS/MMS messages, phone calls, or other methods for communication.

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In one implementation, the technology is implemented in software, which includes but is not limited to firmware, resident software, microcode, etc.

Furthermore, the disclosed technologies can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implemenations of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the modules, routines, features, attributes, methodologies, and other aspects are not mandatory or significant, and the mechanisms that implement the present disclosure or its features may have different names, divisions and/or formats. Furthermore, as should be apparent, the modules, routines, features, attributes, methodologies and other aspects of the present technology can be implemented as software, hardware, firmware, or any combination of the three. Also, wherever a component, an example of which is a module, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

What is claimed is:

1. A method comprising:
receiving, using a computing device, user information relating to a user interest from a source associated with a user;
generating, using the computing device, an external signal based on the user interest;
co-relating the user interest with a plurality of unredeemed user offers based on the external signal and identifying an unredeemed offer appropriate for the user interest;
generating, using the computing device, a notification suggesting the unredeemed offer to the user; and
providing for display to the user, using the computing device, the notification including the appropriate unredeemed offer.

2. The method according to claim 1, wherein the user information comprises one of a group of a user email, a calendar item, a location, a search, a social network stream, and a social graph associated with the user.

3. The method according to claim 2, wherein the location is determined via a global positioning system.

4. The method according to claim 2, wherein a search is performed by a search capability.

5. The method according to claim 1, wherein the user interest includes a user intention.

6. The method according to claim 1, wherein the user interest includes a user action.

7. The method according to claim 1, wherein the user interest includes one of a user preference and a significant event of interest to the user.

8. A computer program product comprising a computer usable medium including a computer readable program, wherein the computer readable program when executed on a computer causes the computer to:
receive user information relating to a user interest from a source associated with the user;
generate an external signal based on the user interest;
co-relate the user interest with a plurality of unredeemed user offers based on the external signal and identify an unredeemed offer appropriate for the user interest;
generate a notification suggesting the unredeemed offer to a user; and
provide the notification for display to the user, the notification including the appropriate unredeemed offer.

9. The computer program product according to claim 8, wherein the user information comprises one of a group of user emails, calendar items, locations, searches, social network streams, and social graphs relating to the particular user.

10. The computer program product according to claim 8, wherein the location is determined via a global positioning system.

11. The computer program product according to claim 8, wherein a search is performed by a search capability.

12. The computer program product according to claim 8, wherein the user interest includes a user intention.

13. The computer program product according to claim 8, wherein the user interest includes a user action.

14. The computer program product according to claim 8, wherein the user information includes one of a user preference or a significant event of interest to the user.

15. A system comprising:
a processor, and;
a memory storing instructions that, when executed, cause the system to:
receive user information relating to a user interest from a source;
generate an external signal based on the user interest;
co-relate the user interest with a plurality of unredeemed user offers based on the external signal and identify an unredeemed offer appropriate for the user interest;
generate a notification suggesting the unredeemed offer to a user; and
provide for display to the user the notification including the appropriate unredeemed offer.

16. The system according to claim 15, wherein the user information comprises one of a group of a user email, a calendar item, a location, a search, a social network stream, and a social graph relating to the user.

17. The system according to claim 15, wherein the location is determined via a global positioning system.

18. The system according to claim 15, wherein a search is performed by a search capability.

19. The system according to claim 15, wherein the user interest includes a user intention.

20. The system according to claim 15, wherein the user interest includes a user action.

21. The system according to claim 15, wherein the user interest includes one of a user preference or a significant event of interest to the user.
